(19) United States
(12) Patent Application Publication
(10) Pub. No.: US 2018/0057956 A1
(43) Pub. Date: Mar. 1, 2018

(54) METHOD FOR FORMING LINEAR GROOVE ON STEEL STRIP AND METHOD FOR MANUFACTURING GRAIN-ORIENTED ELECTRICAL STEEL SHEET

(71) Applicant: JFE STEEL CORPORATION, Chiyoda-ku, Tokyo (JP)

(72) Inventor: Hirokazu KOBAYASHI, Chiyoda-ku, Tokyo (JP)

(73) Assignee: JFE STEEL CORPORATION, Chiyoda-ku, Tokyo (JP)

(21) Appl. No.: 15/538,355

(22) PCT Filed: Dec. 18, 2015
(86) PCT No.: PCT/JP2015/006332

§ 371 Date: Jun. 21, 2017

(30) Foreign Application Priority Data
Dec. 25, 2014 (JP) 2014-262886

(51) Int. Cl. C25F 3/14; C22C 38/02; C21D 9/46; C21D 8/12; C21D 3/04; C23F 1/00; C25F 3/06; H01F 27/245

(52) U.S. Cl. CPC C25F 3/14; C22C 38/02; C21D 9/46; C21D 8/1255; C22C 2202/02; C23F 1/00; C25F 3/06; H01F 27/245; C21D 3/04

(57) ABSTRACT

A resist coating for etching use which enables high speed and high accuracy patterning is provided by applying, to a steel strip, a negative resist ink which solidifies upon exposure to light; drying the ink to form a resist coating; then irradiating the steel strip with light while moving a mask member in synchronization with a traveling speed of the steel strip, the mask member being configured to cover a surface of the resist coating to block light, to thereby solidify a portion of the resist coating not covered with the mask member to form a solidified portion; and removing an unsolidified portion other than the solidified portion with a developing solution. Subsequently, by dissolving and removing by etching a portion of the steel strip below the removed portion of the resist coating, a fine and uniform linear groove can be formed in a surface of the steel strip.

### TECHNICAL FIELD

This disclosure relates to methods for forming linear grooves on steel strips such as steel strips for grain-oriented electrical steel sheets used for iron cores of electrical equipment such as transformers, and to methods for manufacturing grain-oriented electrical steel sheets by applying the same.

### BACKGROUND

Grain-oriented electrical steel sheets are mainly used as iron core materials of transformers, and are required to have good magnetic properties. In order to reduce energy loss in iron core applications, among magnetic properties, iron loss in particular needs to be reduced.

Conventionally, attempts have been made to reduce iron loss by increasing the electrical resistance of the steel sheet by increasing Si content, making the crystal orientation highly accorded with the (110)[001] orientation, reducing the sheet thickness of the steel sheet, and so on.

However, the use of the above metallurgical methods alone sets limits to iron loss reduction. Therefore, in order to achieve a further reduction in iron loss, other conventional techniques have proposed artificially refining magnetic domains.

One conventional magnetic domain refining method includes irradiating a laser beam onto a surface of a final-annealed steel sheet, as described in PTL 1 (JPS572252B). This method is effective for improving iron loss properties after laser irradiation, yet has a problem of iron loss properties being deteriorated by subsequent stress relief annealing. It is thus not preferable to apply this method to electrical steel sheets for wound cores requiring strain relief annealing.

On the other hand, as a technique capable of suppressing deterioration of iron loss properties even after strain relief annealing, JP2942074B (PTL 2) proposes forming linear grooves by etching after applying a resist ink in a linear pattern.

Further, JP3488333B (PTL 3) describes a method for applying a negative resist for photo etching use to produce a precise linear groove pattern to form linear grooves.

Moreover, JPH569284B (PTL 4) describes a method for forming linear grooves using a linear groove pattern produced by applying a positive resist.

### CITATION LIST

### Patent Literature

### PTL 1: JPS572252B

### PTL 2: JP2942074B

### PTL 3: JP3488333B

### PTL 4: JPH569284B

### SUMMARY

### Technical Problem

However, the method of PTL 2 has the problem that when some linear grooves collapse or have discontinuities at the time of applying a resist ink, uniform linear grooves cannot be formed by etching, leading to a variation in magnetic properties.

In addition, such a method for forming a linear pattern by coating as described in PTL 2 has the problem of not being able to guarantee sufficient insulation in the vicinity of the boundary between a resist ink-coated portion and a resist ink-uncoated portion where the coating decreases in thickness since the resist ink is caused to flow out under the influence of leveling action.

To address this issue associated with the flow-out of resist ink, if severe etching is applied from the beginning in an effort to shorten the etching duration, there arises another problem that causes an increase in the non-uniformity of the groove shape at a portion with a small thickness in the vicinity of the boundary between a resist ink-coated portion and a resist ink-uncoated portion.

Moreover, if a narrower groove pattern is produced to reduce etching load, the resist ink coated in that pattern spreads over the uncoated portion. Hence, the method of PTL 2 has a problem that requires a somewhat wide pattern be formed at an uncoated portion.

Further, PTL 3 fails to give consideration to how to perform exposures of continuously-traveling steel strips, and the method of PTL 3 is limited to manufacture of a small strip. Therefore, the method could not be used in applications of magnetic domain refinement which requires forming a narrow linear groove pattern for a large-area steel strip.

Linear groove formation in a steel strip requires etching. When electrolytic etching is carried out, the steel strip must have strong insulating properties.

However, as in PTL 4, the use of a positive resist ink causes an exposed portion to be solubilized by the reaction, in which case the rest of the resist coating other than the removed portion does not have strong insulating properties.

This necessitates another baking treatment in order to cause the resist coating to firmly solidify so that the steel strip is given strong insulation properties. In other words, in the case of using a positive resist ink, the necessity of such additional baking process still remains a problem.

It could thus be helpful to provide a method for forming linear grooves on a steel strip that can form fine and uniform linear grooves on a continuously-traveling steel strip by forming a resist coating thereon, which is obtained by drying a resist ink for negative photo etching use, in a certain pattern at high speed with high accuracy, and etching the steel strip.

It could also be helpful to a method for manufacturing a grain-oriented electrical steel sheet that can form linear grooves on a steel strip for a grain-oriented electrical steel sheet by using the above-described linear groove formation method, to thereby produce a grain-oriented electrical steel sheet having excellent magnetic properties.

### Solution to Problem

Specifically, the primary features of the disclosure can be summarized as follows:

1. A method for forming linear grooves on a steel strip, the method comprising:

applying, to a continuously-traveling steel strip, a negative resist ink which solidifies upon exposure to light;

then drying the negative resist ink to form a resist coating;

then irradiating the steel strip with light while moving a mask member in synchronization with a traveling speed of the steel strip, the mask member being configured to cover a surface of the resist coating to block light, to thereby solidify a portion of the resist coating that is not covered with the mask member to form a solidified portion;

then removing a remaining portion other than the solidified portion of the resist coating with a developing solution; and

then performing etching to dissolve and remove a portion of the steel strip below the removed portion of the resist coating, to thereby form a linear groove.

2. The method for forming linear grooves on a steel strip according to 1., wherein the mask member is provided in the form of an endless belt that loops around a pair of rotating rolls to enable rotational movement of the mask member, the pair of rotating rolls being disposed adjacent to the steel strip and parallelly arranged in a traveling direction of the steel strip, wherein a speed of the rotational movement of the mask member is synchronized with the traveling speed of the steel strip.

3. The method for forming linear grooves on a steel strip according to 1., wherein the mask member is formed in a cylindrical shape and is arranged at a position adjacent to the steel strip with its axis in parallel to the width direction of the steel strip, and at this arrangement position the cylindrical mask member is caused to rotate about the axis as a rotation axis, wherein a peripheral speed of the cylindrical mask member is synchronized with the traveling speed of the steel strip.

4. The method for forming linear grooves on a steel strip according to any one of 1. to 3., wherein a thickness of the resist coating is set to 15 μm or less.

5. The method for forming linear grooves on a steel strip according to any one of 1. to 4., wherein a gap between the mask member and the resist coating is set to 150 μm or less.

6. The method for forming linear grooves on a steel strip according to any one of 1. to 5., wherein a width of the remaining unsolidified portion other than the solidified portion is set to 20 μm or more and 500 μm or less.

7. The method for forming linear grooves on a steel strip according to any one of 1. to 6., wherein a plurality of the linear grooves are formed at an angle of 30° or less with respect to the width direction of the steel strip and at a pitch of 20 mm or less in the longitudinal direction of the steel strip.

8. The method for forming linear grooves on a steel strip according to any one of 1. to 7., wherein a groove depth of each linear groove is set to 5 μm or more.

9. A method for manufacturing a grain-oriented electrical steel sheet, comprising:

heating a silicon steel slab;
then hot rolling the steel slab to obtain a hot-rolled sheet;
optionally subjecting the hot-rolled sheet to hot band annealing;
then subjecting the hot-rolled sheet to cold rolling either once, or twice or more with intermediate annealing performed therebetween, to obtain a steel strip;
then subjecting the steel strip to decarburization annealing;
then applying an annealing separator to the steel strip; and
subsequently subjecting the steel strip to final annealing,
wherein a linear groove is formed in a surface of the steel strip subjected to the cold rolling by applying the method as recited in any one of 1. to 8.

### Advantageous Effect

The present disclosure enables forming fine and uniform linear grooves on a continuously-traveling steel strip by forming thereon a resist coating obtained from a resist for negative photo etching use, in a certain pattern at high speed with high accuracy, and furthermore, eliminates the need for rebaking after etching. As a result, a grain-oriented electrical steel sheet having extremely good magnetic properties may be obtained in a labor-saving manner.

### BRIEF DESCRIPTION OF THE DRAWINGS

In the accompanying drawings:

FIG. 1 illustrates an implementation of the present disclosure;

FIG. 2A and FIG. 2B illustrate thin and thick resist coatings according to the present disclosure;

FIG. 3A and FIG. 3B illustrate an example of use of a mask member during light irradiation according to the present disclosure; and

FIG. 4 illustrates another example of use of a mask member during light irradiation according to the present disclosure.

### DETAILED DESCRIPTION

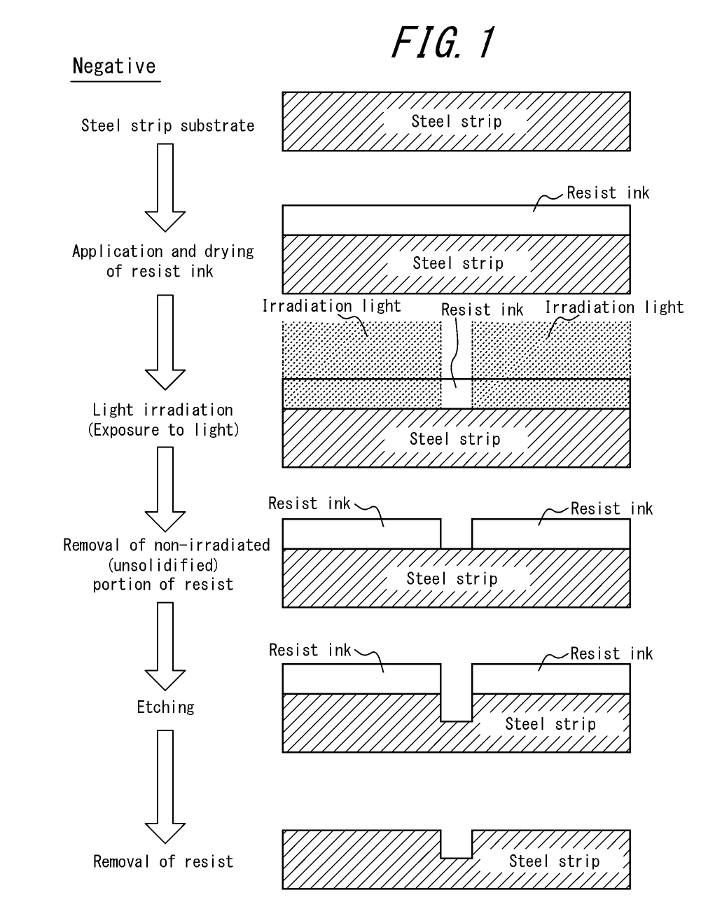

Our methods and products will be described in detail below. The present disclosure relates to a method for forming linear grooves through a process illustrated in FIG. 1 on a steel strip which is continuously traveling (passing) by etching (dissolving and removal of a portion of the steel strip). First, in the present disclosure, a negative resist ink which solidifies upon exposure to light is applied to a steel strip using a coater. At this time, the coating method is not particularly limited as long as it is capable of forming a resist coating having a thickness of 15 μm or less in terms of dry coating thickness (as used herein, a resist coating refers to a dry coating unless otherwise specified), and roll coaters and the like that are often used for film coating on steel strips may be used. As other coating methods, a slit die method, a curtain coater method, an ink jet method, a spray method, or the like may be appropriately selected according to the installation space of the coater and the physical properties of the coating material.

Further, in the present disclosure, a negative resist ink may be used even if it is not liquid, and the resist coating disclosed herein may also be formed by laminating a pre-formed film such as a dry film on the steel strip.

In the present disclosure, the resist ink used is a negative resist ink which is prepared by mixing a photosensitive resin material, which is solidified by light irradiation, and which allows the portion irradiated with light to remain as a mask during etching. By using such negative resist ink, there is no need to form a resist ink-coated portion or a resist ink-uncoated portion, and hence grooves will not be interrupted or stuck due to poor coating of ink, allowing for formation of a uniform groove pattern.

The use of such negative resist ink may also impart good insulating properties to the resist coating itself without the need to perform baking treatment again at high temperature, which would otherwise be required to solidify the remaining portions of the coating in the case of using a positive resist ink. Accordingly, as compared with the case of using a positive ink, the steel strip may be provided with improved insulating properties with fewer steps, and thus it becomes possible to carry out etching treatment of the steel strip, as described later, appropriately.

Therefore, the present disclosure makes it possible to produce a sharp groove pattern at low cost.

Further, as a device used for drying the applied resist ink, it suffices as long as the device can guarantee the drying temperature of the coating material, and the device may be selected appropriately from among an induction heating furnace, a hot-air drying furnace, and the like, depending on the factory utility environment and so on.

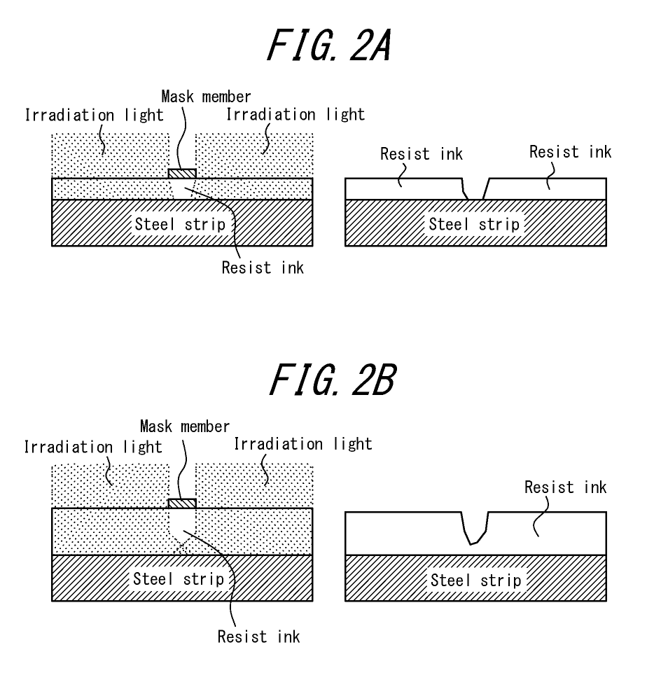

At this time, it is important that the thickness of the resist coating obtained by applying the resist ink and then drying is set to 15 μm or less. The reason is that when the thickness is 15 μm or less, as illustrated in FIG. 2A, a groove-shaped resist pattern from which portions other than the light irradiated portion are removed can be appropriately formed.

If the coating thickness exceeds 15 μm, a reasonable insulation resistance can be secured at the time of etching. When the coating thickness is greater than 15 μm, however, the mask does not function well when irradiated with light, and irregular reflection of light from the steel strip causes excessive exposure up to beneath the mask, making the patterning of the resist coating difficult (see FIG. 2B). If the patterning of the resist coating is unsuccessful, a phenomenon occurs in which a rectangular groove pattern cannot be formed properly and the mask portion is partly solidified, and the coating persistently remains with a small thickness at the bottom of the mask portion even after the resist coating removing step. Such a phenomenon leads to a problem that causes, for example, a spark due to an energizing failure at the time of etching of the steel strip, and ends up causing an etching failure.

Therefore, the thickness of the resist coating is preferably 15 μm or less. The thickness of the resist coating is more preferably 10 μm or less. On the other hand, as long as sufficient insulation resistance for etching can be guaranteed, the coating thickness of the resist coating may be further reduced. However, insulation resistance which ensures successful etching is around 0.5 μm.

As used herein, the thickness of the resist coating is defined as the dry coating thickness after drying, which is determined by averaging the results from observing the thickness at ten locations randomly selected from a cross section of the coating.

In the present disclosure, light irradiation is carried out with light including a specific wavelength range for solidifying the resist ink. As used herein, the specific wavelength range is specifically from 200 nm to 400 nm.

In addition, examples of the light source include one which guarantees a sufficient irradiation dose when irradiating an object with light in the above-described specific wavelength range, such as an extra-high pressure mercury lamp or an excimer lamp. As used herein, the sufficient irradiation dose is specifically from 100 J/m² to 1000 J/m², depending on the sensitivity of the resist ink to curing.

Further, as for the light irradiation device, any device may be used as long as it is capable of irradiating an object with the above-described predetermined light using an ultra-high pressure mercury lamp, an excimer lamp, or the like.

When performing light irradiation in the present disclosure, the mask member is designed to be movable in synchronization with the traveling speed of the steel strip.

In the fields of semiconductor and electronic parts where photo etching is frequently used, exposure processing by light irradiation is generally carried out in a state where the substrate is held stationary. In the steel industry where large-area steel strips travel at high speed, however, it is not preferable from a viewpoint of productivity to conduct light irradiation in a stationary state, and therefore it is necessary to process substrates in a continuous manner.

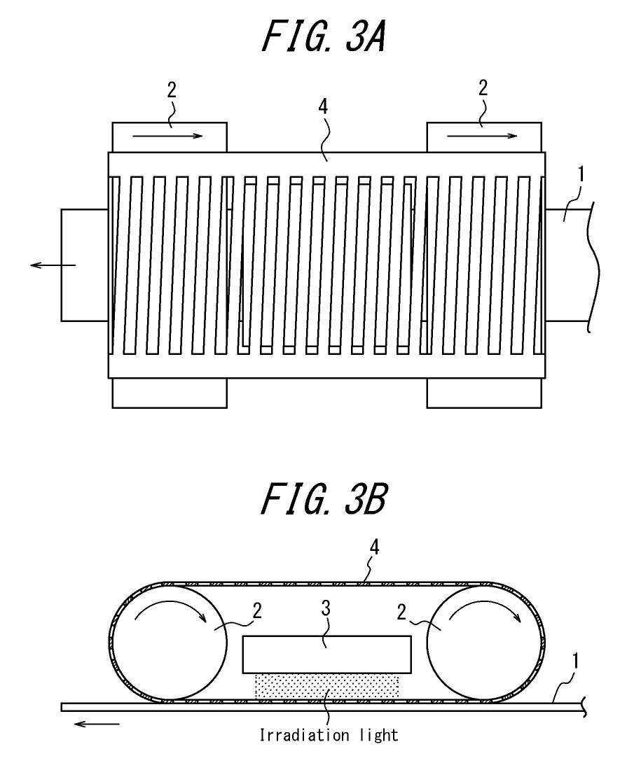

On the other hand, to solidify the resist ink, some long irradiation duration is required. Thus, as illustrated in FIG. 3A and FIG. 3B, for example, a mask member is wrapped around a pair of rotating rolls disposed close to the steel strip, and the rotating rolls are rotated to move the wrapped mask member.

At this time, it is conceivable to adopt a scheme in which light irradiation is carried out with the moving speed of the mask member synchronized with the traveling speed of the steel strip.

As used herein, the movement of the mask member to wrap around the rotating rolls in this manner is called rotational movement. In FIG. 3A and FIG. 3B, reference numeral 1 denotes a steel strip, reference numeral 2 denotes a rotating roll, reference numeral 3 denotes a light irradiation device (light source), and reference numeral 4 denotes a mask member.

By causing rotational movement of the mask member in contact with the steel strip in a manner as shown in FIG. 3A and FIG. 3B, the moving speed of the mask member and the traveling speed of the steel strip can be perfectly synchronized with each other. Having now explained one case where the mask member in the form of an endless belt is wrapped around two rotating rolls to synchronize with the traveling speed of the steel strip, one or three or more rotating rollers may be used. As for the mask member, it is also possible to use a mask member which is not an endless belt, but in the form of, for example, a belt-like mask member wound into a coil, which is taken out of one side to mask the steel strip and taken in the other side.

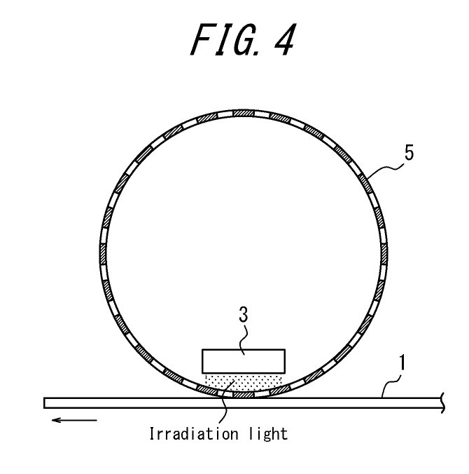

It is also conceivable to adopt a scheme, as illustrated in FIG. 4, in which the mask member is formed in a cylindrical shape and is designed as a rotating-type mask member 5 such that the mask member itself rotates on its rotation axis by means of cantilever support, and light irradiation is carried out with the peripheral speed of the cylindrical mask member synchronized with the traveling speed of the steel strip. The cylindrical shape is not particularly limited as long as light irradiation can be performed with the peripheral speed of the mask member synchronized with the traveling speed of the steel strip. However, considering the gap between the resist coating and the mask member described below, it is preferable to apply a cylindrical shape with small curvature.

In the present disclosure, the gap between the resist coating and the mask member (this gap is defined herein as the range of close arrangement) is preferably 150 μm or less. In the case of masking a narrow area relative to a light-irradiated portion having a large area as in the present disclosure, when the gap between the resist coating and the mask member is larger than 150 μm, the mask portion is also exposed by light diffraction, which causes the resist coating to solidify at the mask portion, resulting in an increase in the non-uniformity of the resist pattern after development. The gap between the resist coating and the mask member is more preferably 100 μm or less, and particularly preferably 0 μm as illustrated in FIG. 3B.

To obtain good electromagnetic properties in the present disclosure, it is desirable to form grooves with a relatively small width. A small groove width is also preferable from the perspective of etching load. Therefore, it is preferable for the present disclosure to set the width of a portion other than the solidified portion (an unsolidified portion) to 20 μm or more and 500 μm or less. If the width is smaller than 20 μm, the resulting light shielding portion of the mask member decreases in width accordingly, and a sufficient light shielding effect cannot be obtained during light irradiation, causing solidification of the entire surface. On the other hand, if the width excluding the solidified portion is larger than 500 μm, a sufficient iron loss property improving effect may not be obtained.

The rotating rolls used in the present disclosure are not particularly limited to particular type and rotating rolls of any type, such as rotation type, belt-driven type, and the like, may be used as long as the moving speed of the mask member can be synchronized with the traveling speed of the steel strip. However, from the perspective of ease of fine adjustment of traveling speed, rotating rolls of rotation type are preferred.

The material of the mask member is not particularly limited as long as it enables covering the surface of the resist coating and blocking the light during light irradiation. In general, such a mask member is used that is obtained by forming a thin metallic film made of chromium or the like into the shape of an exposure pattern to a thickness of about 0.1 μm to 1 μm on a glass substrate of several millimeters in thickness. In the present disclosure, however, from the viewpoint of a mask being transferred in synchronization with the steel strip, a flexible material is suitable, and such a mask can be suitably used that is formed by depositing a thin metallic film made of chromium or the like on a transparent film sheet capable of transmitting light or the like.

Linear grooves are preferably formed in a pattern in which they are formed at an angle of 30° or less with respect to the width direction of the steel strip. If the angle is larger than that, a sufficient iron loss property improving effect cannot be obtained for the final product.

As used herein, the term “linear” is intended to encompass not only straight lines, but also broken lines and continuous lines of points.

In addition, the linear grooves are formed in a pattern in which they are formed at a pitch of 20 mm or less in the longitudinal direction of the steel strip. This is because if the pitch is wider than that, a sufficient iron loss property improving effect cannot be obtained. The pitch is preferably 1 mm or more.

The way of removing the unsolidified portion of the resist coating other than the portion solidified by the light irradiation is appropriately selected depending on the resist composition, yet an easier way is to immerse in an organic solvent or an alkaline solution. To increase the removal rate of the resist coating, an additional measure may be taken, such as heating the steel strip in advance, increasing the solution temperature, generating a flow in the solution tank, or providing a jet nozzle.

The following describes the process of etching a portion of the steel strip below the removed portion of the resist coating.

Etching of the steel strip may be either chemical etching or electrolytic etching, yet electrolytic etching has better controllability since the groove depth can be set by the current passage amount. In the case of electrolytic etching, the electrolysis is preferably performed in an electrolytic bath such as NaCl aqueous solution or KCl aqueous solution, yet there is no particular limitation, and it may be performed in accordance with conventional methods. The groove depth to be etched is preferably 5 μm or more. If the groove depth is shallower than that, a sufficient iron loss property improving effect cannot be obtained. The upper limit for the groove depth to be etched is not particularly limited, yet it is about half the sheet thickness in consideration of productivity and the like.

The steel strip after subjection to the etching is conveyed to a resist-coating stripping apparatus. Unnecessary portions of the resist coating remaining after the etching, which would adversely affect the downstream processes, are removed by the resist stripping equipment to clean the steel sheet. The stripping process is not particularly specified, yet includes immersing the steel strip in an alkaline solution or an organic solvent such as sodium hydroxide or sodium orthosilicate. Physical stripping means such as brushes and scrapers may be used in combination.

As regards the method for manufacturing a grain-oriented electrical steel sheet, the method comprises: heating a silicon steel slab; then hot rolling the steel slab to obtain a hot-rolled sheet; optionally subjecting the hot-rolled sheet to hot band annealing; then subjecting the hot-rolled sheet to cold rolling either once, or twice or more with intermediate annealing performed therebetween, to obtain a cold rolled steel strip; then subjecting the steel strip to decarburization annealing; then applying an annealing separator to the steel strip; and subsequently subjecting the steel strip to final annealing. In this respect, it is advantageous that the above-described method for forming linear grooves is applied to form a linear groove in a surface of the cold rolled steel strip.

In other words, in manufacturing a grain-oriented electrical steel sheet, magnetic domain refinement may be achieved by forming linear grooves in a surface of the steel strip subjected to the cold rolling by applying the above-described method for forming linear grooves, and the resulting grain-oriented electrical steel sheet may have excellent magnetic properties.

After the formation of the linear grooves, the cold rolled steel strip may be subjected to decarburization annealing (primary recrystallization annealing) in accordance with a conventional method and subsequently to final annealing (secondary recrystallization annealing), whereby a grain-oriented electrical steel sheet according to the present disclosure may be obtained.

In the present disclosure, conditions other than those described above, such as the chemical composition of the steel strip, steps for manufacturing the grain-oriented electrical steel sheet, and the like, may be in accordance with conventional methods.

### EXAMPLES

Under the respective conditions listed in Table 1, a negative resist ink was applied to each cold rolled steel strip of 0.23 mm in sheet thickness containing 3.3 mass % of Si, which in turn was subjected to drying, light irradiation, removal of a portion of the resist coating other than the solidified portion (an unsolidified portion), and electrolytic etching. Then, after removal of the remaining solidified portion of the resist coating, each steel strip was subjected to decarburization annealing followed by final annealing, and the magnetic properties of each grain-oriented electrical steel sheet thus obtained were evaluated.

In this case, linear grooves were formed at an angle of 10° with respect to the width direction of the corresponding steel strip, at a pitch of 3 mm in the longitudinal direction of the steel strip, and with a groove depth of 30 μm.

For resist coating formation, a resist ink containing an acrylic group-containing resin and the like was used. As a drying furnace, a hot-air drying furnace at a furnace temperature of 250° C. was used for drying. As a light source, an extra-high pressure mercury lamp was used. Removal of portions other than the solidified portion of the resist coating was carried out by immersion in an alkaline solution.

As a comparative example, a steel sheet was prepared with a resist ink pattern-printed thereon by offset gravure roll printing following a conventional method, then subjected to etching, and evaluated for magnetic properties.

With regard to the rolls used in the offset gravure roll coater, the gravure roll used was a hard chrome-coated grooved roll and the offset roll was a rubber roll lined with rubber. The gravure roll used had a groove shape such that each uncoated portion was 100 μm in width in the rotation direction and each coated portion was 3 mm in width in the rotation direction. The rubber lining thickness was 20 mm, the rubber was urethane rubber, and the hardness was Hs 80°. The roll diameter was 250 mm for both the gravure roll and the offset roll. The coating liquid used was a resist ink mainly composed of an alkyd-based resin. In use, the resist ink was diluted with ethylene glycol monobutyl ether and adjusted to a viscosity at 20° C. of approximately 1500 mPa·s.

Electrolytic etching was performed for several tens of seconds in an NaCl electrolytic bath at a current density of 30 A/dm² until a groove depth of 30 μm was reached.

In this example, iron loss W_{17/50} was evaluated at 1.7 T, 50 Hz. As for the appearance, it was determined to be (i) “poor” when discontinuities or deformation was observed in the linear grooves, (ii) “unsatisfactory” or “satisfactory,” which was judged taking into account the results of iron loss evaluation, when a minor variation in groove depth or deformation was observed, or (iii) “excellent” when linear grooves were distinctly formed with a uniform depth.

The iron loss and appearance evaluation results of our examples and the comparative example are also listed in Table 1.

TABLE 1

| | Thicknes of | Width of | | | | |
|---|---|---|---|---|---|---|
| | resist coating | unsolidified portion | Gap*¹ | Groove | W_{17/50} | |
| Scheme | [μm] | [μm] | [μm] | shape | [W/kg] | Remarks |
| Negative resist | 2 | 50 | 50 | Excellent | 0.79 | Example |
| Negative resist | 3 | 50 | 50 | Excellent | 0.78 | Example |
| Negative resist | 5 | 50 | 50 | Excellent | 0.79 | Example |
| Negative resist | 10 | 50 | 50 | Excellent | 0.79 | Example |
| Negative resist | 15 | 50 | 50 | Good | 0.80 | Example |
| Negative resist | 20 | 50 | 50 | Fair | 0.81 | Example |
| Negative resist | 3 | 20 | 50 | Excellent | 0.78 | Example |
| Negative resist | 3 | 15 | 50 | Fair | 0.81 | Example |
| Negative resist | 3 | 200 | 100 | Excellent | 0.79 | Example |
| Negative resist | 3 | 500 | 150 | Good | 0.80 | Example |
| Negative resist | 3 | 600 | 150 | Good | 0.81 | Example |
| Negative resist | 3 | 100 | 200 | Fair | 0.81 | Example |
| Negative resist | 3 | 200 | 200 | Fair | 0.81 | Example |
| Gravure offset printing | 3 | — | — | Poor | 0.83 | Comparative Example |

*¹The gap between the resist coating and the mask member.

It can be seen from Table 1 that in our examples, the use of a negative resist ink and a light irradiation device enabled formation of uniform resist coating patterns and formation of uniform linear grooves by etching. Our examples also gave better results for magnetic properties.

In contrast, the comparative example using conventional offset gravure roll printing gave inferior results for magnetic characteristics after etching, since coating unevenness and spreading of the ink occurred and caused appearance defects and collapse of grooves, preventing stable formation of uniform linear grooves with high accuracy.

Although the above examples have been described in the context of grain-oriented electrical steel sheets being manufactured by using cold rolled steel strips having a thickness of 0.23 mm as substrates, the present disclosure is not so limited. The present disclosure may be equally applied to steel strips and electrical steel sheets of other thicknesses.

### REFERENCE SIGNS LIST

1 steel strip
2 rotating roll
3 light irradiation device (light source)
4 mask member
5 rotating mask member

1. A method for forming linear grooves on a steel strip, the method comprising:
applying, to a continuously-traveling steel strip, a negative resist ink which solidifies upon exposure to light;
then drying the negative resist ink to form a resist coating;
then irradiating the steel strip with light while moving a mask member in synchronization with a traveling speed of the steel strip, the mask member being configured to cover a surface of the resist coating to block light, to thereby solidify a portion of the resist coating that is not covered with the mask member to form a solidified portion;
then removing a remaining portion other than the solidified portion of the resist coating with a developing solution; and
then performing etching to dissolve and remove a portion of the steel strip below the removed portion of the resist coating, to thereby form a linear groove.

2. The method for forming linear grooves on a steel strip according to claim 1, wherein the mask member is provided in the form of an endless belt that loops around a pair of rotating rolls to enable rotational movement of the mask member, the pair of rotating rolls being disposed adjacent to the steel strip and parallelly arranged in a traveling direction of the steel strip, wherein a speed of the rotational movement of the mask member is synchronized with the traveling speed of the steel strip.

3. The method for forming linear grooves on a steel strip according to claim 1, wherein the mask member is formed in a cylindrical shape and is arranged at a position adjacent to the steel strip with its axis in parallel to the width direction of the steel strip, and at this arrangement position the cylindrical mask member is caused to rotate about the axis as a rotation axis, wherein a peripheral speed of the cylindrical mask member is synchronized with the traveling speed of the steel strip.

4. The method for forming linear grooves on a steel strip according to claim 1, wherein a thickness of the resist coating is set to 15 μm or less.

5. The method for forming linear grooves on a steel strip according to claim 1, wherein a gap between the mask member and the resist coating is set to 150 μm or less.

6. The method for forming linear grooves on a steel strip according to claim 1, wherein a width of the remaining unsolidified portion other than the solidified portion is set to 20 μm or more and 500 μm or less.

7. The method for forming linear grooves on a steel strip according to claim 1, wherein a plurality of the linear grooves are formed at an angle of 30° or less with respect to the width direction of the steel strip and at a pitch of 20 mm or less in the longitudinal direction of the steel strip.

8. The method for forming linear grooves on a steel strip according to claim 1, wherein a groove depth of each linear groove is set to 5 μm or more.

9. A method for manufacturing a grain-oriented electrical steel sheet, comprising:
heating a silicon steel slab;
then hot rolling the steel slab to obtain a hot-rolled sheet;
optionally subjecting the hot-rolled sheet to hot band annealing;
then subjecting the hot-rolled sheet to cold rolling either once, or twice or more with intermediate annealing performed therebetween, to obtain a steel strip;
then subjecting the steel strip to decarburization annealing;
then applying an annealing separator to the steel strip; and
subsequently subjecting the steel strip to final annealing,
wherein a linear groove is formed in a surface of the steel strip subjected to the cold rolling by applying the method as recited in claim 1.

10. A method for manufacturing a grain-oriented electrical steel sheet, comprising:
heating a silicon steel slab;
then hot rolling the steel slab to obtain a hot-rolled sheet;
optionally subjecting the hot-rolled sheet to hot band annealing;
then subjecting the hot-rolled sheet to cold rolling either once, or twice or more with intermediate annealing performed therebetween, to obtain a steel strip;
then subjecting the steel strip to decarburization annealing;
then applying an annealing separator to the steel strip; and
subsequently subjecting the steel strip to final annealing,
wherein a linear groove is formed in a surface of the steel strip subjected to the cold rolling by applying the method as recited in claim 2.

11. A method for manufacturing a grain-oriented electrical steel sheet, comprising:
heating a silicon steel slab;
then hot rolling the steel slab to obtain a hot-rolled sheet;
optionally subjecting the hot-rolled sheet to hot band annealing;
then subjecting the hot-rolled sheet to cold rolling either once, or twice or more with intermediate annealing performed therebetween, to obtain a steel strip;
then subjecting the steel strip to decarburization annealing;
then applying an annealing separator to the steel strip; and
subsequently subjecting the steel strip to final annealing,
wherein a linear groove is formed in a surface of the steel strip subjected to the cold rolling by applying the method as recited in claim 3.

12. A method for manufacturing a grain-oriented electrical steel sheet, comprising:
heating a silicon steel slab;
then hot rolling the steel slab to obtain a hot-rolled sheet;
optionally subjecting the hot-rolled sheet to hot band annealing;
then subjecting the hot-rolled sheet to cold rolling either once, or twice or more with intermediate annealing performed therebetween, to obtain a steel strip;
then subjecting the steel strip to decarburization annealing;
then applying an annealing separator to the steel strip; and
subsequently subjecting the steel strip to final annealing,
wherein a linear groove is formed in a surface of the steel strip subjected to the cold rolling by applying the method as recited in claim 4.

13. A method for manufacturing a grain-oriented electrical steel sheet, comprising:
heating a silicon steel slab;
then hot rolling the steel slab to obtain a hot-rolled sheet;
optionally subjecting the hot-rolled sheet to hot band annealing;
then subjecting the hot-rolled sheet to cold rolling either once, or twice or more with intermediate annealing performed therebetween, to obtain a steel strip;
then subjecting the steel strip to decarburization annealing;
then applying an annealing separator to the steel strip; and
subsequently subjecting the steel strip to final annealing,
wherein a linear groove is formed in a surface of the steel strip subjected to the cold rolling by applying the method as recited in claim 5.

14. The method for forming linear grooves on a steel strip according to claim 2, wherein a thickness of the resist coating is set to 15 μm or less.

15. The method for forming linear grooves on a steel strip according to claim 3, wherein a thickness of the resist coating is set to 15 μm or less.

16. The method for forming linear grooves on a steel strip according to claim 2, wherein a gap between the mask member and the resist coating is set to 150 μm or less.

17. The method for forming linear grooves on a steel strip according to claim 3, wherein a gap between the mask member and the resist coating is set to 150 μm or less.

18. The method for forming linear grooves on a steel strip according to claim 4, wherein a gap between the mask member and the resist coating is set to 150 μm or less.

19. The method for forming linear grooves on a steel strip according to claim 14, wherein a gap between the mask member and the resist coating is set to 150 μm or less.

20. The method for forming linear grooves on a steel strip according to claim 15, wherein a gap between the mask member and the resist coating is set to 150 μm or less.
